(19) United States
(12) Patent Application Publication
(10) Pub. No.: US 2004/0025576 A1
(43) Pub. Date: Feb. 12, 2004

(54) Sensing apparatus and method for fluid samples using sound waves

(76) Inventors: Antony Robert Glauser, Sussex (GB); Paul Andrew Robertson, Hertfordshire (GB); Christopher Robin Lowe, Essex (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/399,876

(22) PCT Filed: Oct. 24, 2001
(86) PCT No.: PCT/GB01/04718

(30) Foreign Application Priority Data
Oct. 24, 2000 (GB) 0026021.6

(51) Int. Cl. G01N 29/02

(52) U.S. Cl. 73/61.79; 73/602

(57) ABSTRACT

PURPOSE: To provide the biosolution sensor enabling a high accuracy and a small size with an SH-SAW device.

CONSTITUTION: This device is a piezoelectric SH mode elastic surface wave sensor and is characterized by disposing an electric short circuit and an electric open circuit on the transmission surface of SH-elastic surface wave, arranging a specimen cell, and immobilizing an enzyme on the specimen cell.

### TECHNICAL FIELD

The present invention relates to sensors and, more particularly, to sensors for detecting chemical and biological properties of samples of material which may be prepared as a liquid or as a surface coating.

### BACKGROUND ART

Known sensors may operate by means of examining the interactions of fluid samples with a prepared sensitive surface. Typical methods involve:

the detection of changes in the mass of layers attached to the surface (such as Surface Acoustic Wave devices),

the detection of changes in the optical properties of layers attached to the surface (such as Surface Plasmon Resonance devices),

the detection of changes in the acidity of layers attached to a chemically active surface, thereby altering the electrical potential of the surface relative to the sample (such as Glucose Oxidase modified EISFET pH probes),

the detection of a steady ‘streaming’ current arising from the controlled flow of fluid across or through a sample, the magnitude of which is dependent on the chemical properties of the sample surface.

Typically, the sensor surface is prepared by coating it with a chemical or biological agent which interacts specifically with the species to be detected, thereby conferring selectivity (however, it should be noted that the sensor surface may be prepared with a coating of the unknown sample such that the interaction with a known liquid provides the required information). Alternatively, the inherent chemical nature of a suitable surface may be sufficient to provide the desired chemical sensitivity (pH EISFETs) (see, for example, Powner, E. T., and Yalcinkaya, F., Sensor Review Vol. 17, No. 2 (1997) pp107-116 “Tutorial—Intelligent Biosensors”). These methods often require the use of specialised components to carry out the detection, which must be discarded after use, on account of contamination and the unit cost of these components is often substantial.

Other prior art methods have been proposed for studying the chemical and physical properties of liquid samples, for example, by detecting electrical signals generated across the bulk of such a sample when subjected to ultrasonic waves. The basis for these methods is summarised in U.S. Pat. No. 4,497,208, “Measurement of electro-kinetic properties of a solution”, It should be noted that these methods rely on generation of the electrical signal in the bulk of the fluid.

It has also been observed (see Yeager, E. and Hovorka, F., The Journal of the Acoustical Society of America, Vol. 25, No. 3 (May 1953) pp. 443-469. “Ultrasonic Waves and Electrochemistry”) that an electrical signal can be detected at electrodes surrounded by fine fibres, immersed in a liquid, when exposed to ultrasound. This represents a development of the colloid vibration potential method referred to in U.S. Pat. No. 4,497,208. Yeager also observed a modulation of the potential of a current-carrying electrode immersed in a solution, which was attributed to modulation of the electrical resistance presented by a bubble-bearing layer in front of the electrode. The effects underlying this disclosure occur in the absence of bubbles and electrolytic currents at the electrode surface.

### DISCLOSURE OF THE INVENTION

According to the present invention, there is provided a method of detecting the chemical and/or biological properties of a fluid, or of a surface in contact with a fluid, the method comprising

disposing the fluid in a vessel having a detector for measuring electrical or magnetic signals generated in the fluid immediately adjacent to a surface of the detector;

using an acoustic source to generate sound waves and direct the sound waves at the detector surface; and

measuring the electrical or magnetic signals generated in the fluid immediately adjacent to the detector surface by the detector at the time when the sound waves impinge on the fluid immediately adjacent to the detector surface.

In one of the two modes (Mode A), the sound waves are directed at the sensor surfaces such that the pressure amplitude and phase of the sound are both uniform across a given sensor surface, resulting in no significant oscillatory fluid motion parallel to the sensor surface. The receiver will typically consist of an electrode associated with each sensor surface, detecting either

a change in the potential of one sensor surface with respect to another, or

a current flowing between two such electrodes,

at the time when the sound waves impinge on said one or more sensor surfaces.

In the other Mode (Mode B), the sound waves are directed such that oscillatory fluid motion parallel to a given sensor surface is induced by a non-uniform distribution of the phase and/or magnitude of the sound waves across the sensor surface.

The receiver may typically consist of

a pair of electrodes associated with each sensor surface, detecting either a potential difference or a current flowing between the two, or

a magnetic pickup (such as a coil) in the vicinity of the sensor surface, detecting a magnetic field generated by the local flow of current,

at the time when the sound waves impinge on said one or more sensor surfaces.

The invention also includes a sensing apparatus for detecting the chemical and/or biological properties of a fluid, or of a surface in contact with a fluid, the apparatus comprising:

a vessel for containing the fluid;

a sensing surface in the vessel;

a detector for measuring electrical or magnetic signals generated in a fluid in the vessel immediately adjacent the sensing surface;

an acoustic source arranged to generate sound waves and direct the sound waves at the sensing surface; and

an electrical circuit connected to the detector and arranged to measure the electrical or magnetic signals generated in the fluid immediately adjacent the sensing surface by the detector at the time when the sound waves impinge on the fluid immediately adjacent the sensing surface.

In the most basic form of the invention, the vessel may contain just two electrodes each side of an intervening surface (such as an insulator). Preferentially implementing Mode A, each electrode comprises a sensor surface, with the sound impinging uniformly on only one of them. For Mode B, the pair of electrodes comprises a receiver, the intervening surface acts as the sensor surface, and the sound impinges non-uniformly on this intervening surface.

For the purposes of illustration, this embodiment is generally assumed in the following discussion—although it will be apparent from the explanations below that many other variations may be used. For example, in Mode A two identically prepared electrodes may be subjected to the same sound source but spaced apart to achieve a time- or phase-lag between the pressure waveforms at their respective surfaces. Alternatively, two electrodes may be subjected to identical pressure waveforms, but differently prepared so that the observed signal represents the difference between the individual signals generated at the respective electrode surfaces. For Mode B, the pair of electrodes comprising the receiver may be replaced by a single magnetic coil. In any such embodiment, the underlying method is the same. Also, hereinafter, the term ‘electrode’ may be understood to refer either to a conductive surface in contact with the fluid, or equally to a conductor coated with an insulating layer, such that signals generated at the surface of the insulating layer (the sensing surface) are coupled capacitively to the conductor.

The apparatus and method of the invention operate by detecting electrical currents or potentials generated in the immediate vicinity of the sensing surface, by the action of sound waves on charged or polarised species associated with the surface. The surface represents a discontinuity in the acoustic medium, which serves to provide the well-defined conditions under which these signals are generated. The disclosed method should not be confused with prior art such as the Ionic Vibration Potential, wherein an electric field propagates with a freely travelling sound wave in a fluid.

Mode A preferentially detects a phenomenon in which electrical signals arise from the oscillatory variation in density of the charge-bearing fluid layer immediately adjacent to the sensor surface. This is in no way related to the Colloid Vibration Potential, or similar mechanisms, since it does not rely on the relative motion of charged particles as induced by a pressure gradient.

Mode B preferentially detects the electrical current induced by the oscillatory motion of fluid-borne charged particles tangential to a surface. These particles are usually associated with the underlying surface, and their number and type will vary with the nature of the surface. It may be argued that this bears a fundamental relationship to the use of streaming currents observed as a result of the steady flow of fluid across a prepared surface (see, for example, Norde, W. and Rouwendal, E., The Journal of Colloid and Interface Science, Vol. 139, No. 1 (October 1990) pp169-176. “Streaming potential measurements as a tool to study protein adsorption kinetics”.) However, the step of using sound waves to induce well defined and localised oscillatory fluid motion at a flat surface is not obvious. It brings with it many advantages over existing techniques:

The detection of a steady streaming current is usually achieved by means of detecting the steady potential drop across a channel (containing the sensor surface) which requires compound electrolytic electrodes (such as a silver/silver-chloride electrode). In Mode B disclosed here, these may be replaced by much simpler conductive contacts (such as evaporated gold) with no loss of performance.

The detection of a steady streaming current usually requires the use of a complex fluid-flow control system, to ensure a well-defined fluid flow over the sensor surface this is unnecessary here, since the sound waves induce well-defined fluid motion. Multiple sensor surfaces may be placed in one fluid sample (in a two-dimensional array, for example) and monitored separately using Mode B, by virtue of the localised nature of the effect.

Sensitivity is greatly increased owing to the high-frequency nature of the signal, eliminating the low-frequency drift and noise commonly associated with electrolytic electrodes and electronic circuitry.

The chemical or biological properties of the surface and/or sample may be deduced directly from the nature of the electrical signal generated by these mechanisms, or they may be deduced from changes in this signal resulting from the action of additional stimuli (such as additional chemical or biological agents, applied electrical potentials, magnetic fields, light).

The transducer will typically be pulsed, with the detection circuitry set to respond to the electrical signal arising at the receiver(s) during periods when the transducer is not driven. Hence the time delay between transmission and arrival of the sound pulse serves to separate the signal to be detected from stray electrical signals generated by the transducer driver circuitry. The pulses may be narrow so as to permit time-domain interpretation of the observed signal, thereby isolating contributions from spatially separated mechanisms or sources, or they may consist of sinusoidal bursts, for an improved signal-to-noise ratio.

In the disclosed method and apparatus the signal which yields the desired information is generated as the sound waves impinge on the sensing surface, by the action of the waves on the charged layers associated with the surface itself. Hence other signals generated away from the sensor surface which are of no use in this method may either be separately accounted for using time-domain discrimination, or the insignificance of their contribution may be asserted using time-domain interpretation of a sample pulse signal. In the latter case, longer sinusoidal waveforms (for example) may then be used to stimulate the signal in the knowledge that the majority of the observed voltage or current arises at the sensing surface. It should be possible, by appropriate choice of waveforms and electrode geometries, to minimise the contribution of unwanted signals generated in the bulk of the fluid or at surfaces adjacent to the intended sensing surface.

Using Modes A and B as applied to the simple embodiment described above, the electrical signal may be detected in the form of a varying potential if one electrode (on which the sound waves impinge, in Mode A—hence referred to as the “target electrode”) is connected to a high-impedance amplifier, or as a current if this electrode is held at virtual earth by a current-to-voltage converter. The other electrode (known as the counter-electrode) provides the second electrical connection to the fluid, completing the circuit.

The sensor surface may be specially prepared by the attachment of chemical or biological substances (such as antibodies) which provide a specific interaction with fluid-borne species to be detected, thereby providing a means of analysing a fluid sample. Alternatively, the fluid may be the known factor, with the sensor surface representing the unknown factor for study (either after the attachment of a layer of a substance to be studied, or in its native form. The latter could be useful for example, in studying the progress of corrosion at a metal surface).

A third, electrochemical electrode (such as a Saturated Calomel Electrode) may be placed in electrochemical contact with the sample fluid, by means of a salt bridge (for example) to enable the measurement of the mean potential of the target electrode with respect to the fluid.

Many practical variations of the basic apparatus exist, though the underlying method is the same; for example:

The sensor surface can be replaced by an (addressable) array of sensor surfaces (with associated receivers), each site sensitive to a different chemical or biological agent, thereby providing the means to carry out a range of tests simultaneously on one sample of fluid.

The sensor surface can be integrated in to a disposable cuvette which serves to hold the sample fluid, or it may be separately inserted in to a through-flow cell designed to provide a means of passing different fluids over the sensor surface without removing it.

The electrical connection to any electrodes can take the form of a close capacitive coupling through an insulator, such that the electrodes may be sealed in to a thin-walled plastic cell with no need for conductive connections passing through the cell wall. Equally, the sensing surface may be a selected part of the plastic cell wall, with the associated electrodes being outside of the cell.

The sound field generated by the acoustic source can be shaped—for example, a lens can be attached to the source to focus the sound on to a specific area.

The medium though which the sound waves travel before entering the sample fluid and striking the sensor surface (introducing the useful delay between sound transmission and arrival) can take the form of a solid or a liquid. In the former case, a gel layer may be advantageous to couple the sound efficiently in to the sample container. In the latter case, the sample container may simply be immersed in a bath of fluid, as in the original prototype detailed below.

The sound source can be placed behind the sensor surface, or indeed mechanically integrated with the sensor surface itself.

The sensor surfaces(s) can be subjected to additional stimuli to monitor their effects on the basic signal. For example:

Stepped electrical biases applied between the electrodes can disrupt the ionic equilibrium at the electrode surface. The resulting response of the signal (obtained more strongly using Mode A) to a sudden change in the mean electrode potential can indicate the extent of reaction between sensitive molecules deliberately attached to the electrode surface and species present in the fluid.

More intense acoustic pulses can be used to deliberately detach species bound to the surface, with the extent of signal change indicating the quantity of the species originally attached, or the amplitude of the acoustic stimulus required to cause detachment indicating the strength of binding to the surface.

The invention is able to provide a novel and low-cost means for studying the properties of a surface immersed in a fluid, the properties of a layer specifically associated with the sensor surface, or the properties of the fluid itself (deduced from the behaviour of the electrode), including the way in which these properties change in response to chemical or biological processes or stimuli.

Applications range from analysis of the electrochemical interface itself (including corrosion monitoring) to the monitoring of biological or chemical activity of the associated layer, or the fluid sample.

For example, if the sensor surface is pre-coated with a particular antibody, the corresponding antigen (if present in the fluid sample) will attach to the former and modify the surface. This change can be detected as a change in the electrical signal for a given acoustic stimulus, providing the means to detect pathogens quickly and with a minimum of material cost per measurement. An added advantage of using sound in this case is that it has the potential to preferentially detach non-specifically adsorbed proteins, not associated with the binding reaction being monitored, which can otherwise produce false signals in conventional biosensing methods.

An important aspect of the design is the potential simplicity of the components of the apparatus which are placed in contact with the fluid sample, since these components will often need to be replaced after each experiment. (For example, if the apparatus is used for detecting the presence of diseases in a blood sample, all components which have come in to contact with the sample are potentially contaminated with infectious agents and therefore cannot be re-used.)

Hence, applications of the invention include, for example:

blood tests (detection of blood proteins, diseases, antigens)

monitoring of pollution in water

monitoring of corrosion at a metal surface

drug testing

genetic screening

detection of biological or chemical agents

evaluation of surface coating or electroplating processes.

The relative positions of the electrodes within the system are not critical to the functioning, and the sample of fluid may be very small without incurring a low sensitivity. The phenomenon does not rely on the evolution of gas at the electrode surface. The immobilisation of a layer on the sensor surface provides a means of localising and concentrating the biological or chemical processes being studied.

The presence of the sensor surface, as a well-defined discontinuity in the acoustic medium, is an essential feature of the method and apparatus, since it provides an interface against which well-determined fluid motion and compression occurs in response to the sound waves. The electrode surface is also extremely controllable (especially with respect to electrical potentials/fields), and provides a special environment for studying immobilised proteins. (e.g. the use of DC bias steps to sweep ions backwards and forwards through a layer of adsorbed protein, monitoring the time response so as to obtain information on the ionic permeability of the layer. Frequency mixing techniques represent another practical implementation of this concept.) If appropriately prepared, the proteins may be uniformly oriented at the surface, making it easier to study them and extract coherent data relating to their structure.

In current probe mode (i.e. with the electrodes connected to a current-to-voltage converter) both electrodes are held at earth potential. Hence an array of differently sensitized electrodes may be electrically connected together, with one common connection to the amplifier. The array is addressed simply by directing sound to the selected sensor surface; the signal generated flows as a current in to the common terminal, but since the entire array is held at earth potential there is no significant “leakage” of the signal back in to the solution via unstimulated areas. This avoids the need for complex addressing circuitry and multiple electrode connections, significantly reducing the complexity and cost of a practical implementation.

Addressing may also be achieved by focussing the sound as a stripe across an array of columns, where the electrodes for the target spots within a column are connected together. Hence the sound focussing selects the row, and an external connection selects the column. Faster scanning of an array may be achieved this way.

Acoustic stimulation of the sensor surface also provides a means of controlling adsorption; in particular, it may prove useful in reducing non-specific adsorption of unrelated proteins on to receptors, thereby enhancing the system sensitivity and selectivity. Varying the acoustic intensity in a predetermined way also provides a means for measuring the strength of binding. Also, the acoustic stimulation may help to accelerate the interactions between receptor and analyte molecules, such that the device achieves a faster response time.

Additional stimuli (such as DC bias steps applied to the target electrode) may have to be used in conjunction with the acoustic stimulation to extract sufficient information for unambiguous interpretation of data. This flexibility is not necessarily available to all techniques, and represents an important aspect of the method (i.e. the dual-stimulation of the electrode.)

With respect to Mode A:

The data obtained are likely to be predominantly a combination of acoustic and electrical information, in the respect that electrical-impedance-type data can be obtained using acoustic stimulation. This method has a significant advantage over conventional electrical-impedance measurement methods. Providing a sufficient time delay is used, the acoustic source is electrically silent when the signal is generated at the electrodes. Hence impedance-type data can be obtained without the stray coupling that usually hinders impedance measurement methods.

Since the acoustic pulse should evenly compress the material in front of the electrode, there is not necessarily any relative motion of adjacent ions, hence the ionic distribution should remain relatively unchanged after measurement. This is in sharp contrast to conventional electrical impedance methods where the measurement process directly disrupts the ionic distribution. In this sense, the method described above can be less invasive.

With respect to Mode B:

The data obtained are likely to be largely similar in nature to those obtained using conventional steady-flow streaming techniques, though with considerably reduced experimental complexity.

The use of pulses with appropriate triggering circuitry ensures that phase data can be recovered unambiguously from the measured signal, as well as polarity data. If a single continuous sinewave were used, it would be very hard to extract the phase of these Surface Electro-Acoustic signals relative to the phase of the sound wave at the surface of the electrode. This relative phase angle may prove essential in extracting useful data from the system, it being separate from the signal amplitude.

Pulses also make it possible to isolate different components of the signal—if for example, a strong “stray” signal were generated by an Ionic Vibration Potential in the bulk of the sample fluid, it would still be possible to isolate the Surface Electro-Acoustic signals using time discrimination, since the former would be generated some microseconds before the latter. The signals are generated by the relative motion of charges and dipoles within or immediately either side of the layer(s) associated with the sensor surface. The layer(s) may comprise specifically chosen substances exhibiting sensitivity to a particular species to be detected, or they may comprise the layers of charged particles normally present at an interface with a fluid (the ‘Electrical Double-Layer’).

The nature of the signals will depend on

The mechanical & chemical properties of the charge-bearing layer (such as thickness or compressibility).

The electrical properties of the layer (such as charge content and polarizability).

The properties of the sensor surface (such as effective surface area and specific charge content).

The ease with which charge may move within the layer or between constituents of the layer (for example, the strength of bonds between charged or polarised particles, or between sections of a compound particle.)

Changes in these properties are expressed as a change in the signal, with the dependence on acoustic waveform shape and intensity providing further parameters with which to extract information from the layer. For example, the conformational properties of particular proteins may yield a frequency or time dependence which can be considered as a ‘fingerprint’ for that particular protein or its state of interaction with another protein.

A modification is envisaged in which the signals referred to above comprise individual frequency components of an electrical signal, which are generated as a result of the modulation of the passive electrical properties of the layer(s) adjacent to the sensor surface during excitation by an additional electrical stimulus. For example, if an alternating electrical signal is applied across the electrodes at frequency f₁, an alternating current will flow between the electrodes at frequency f₁, the magnitude of which will depend partly on the electrical properties of the layers associated with the electrodes. If these layers are then exposed to acoustic waves at frequency f₂, their electrical properties will be modulated such that frequency mixing occurs, with the resulting generation of electrical signal components at frequencies (f₁+f₂) and (f₁−f₂).

The basic phenomena described earlier, whereby electrical signals are generated directly by sound waves without additional electrical stimulus, can be seen to be a limiting case of this development with the conditions that f₁ is zero.

In a further general aspect, the present invention provides a method of characterising chemical and/or biological properties of a fluid/solid body interface, the method comprising:

providing a solid body having a sensor surface,

immersing the sensor surface in a fluid,

directing sound waves through the fluid to impinge at the sensor surface, and

measuring electrical or magnetic signals generated in the fluid at the sensor surface when the sound waves impinge on the solid body, which signals characterise chemical and/or biological properties of the fluid/solid body interface at the sensor surface. Typically the sound waves are substantially entirely reflected from the sensor surface.

Consistent with Mode A, at least a portion of the measured electrical or magnetic signals may be generated by a density oscillation in the fluid at the interface. Consistent with Mode B, at least a portion of the measured electrical or magnetic signals may be generated by oscillatory lateral displacement of the fluid at the interface, i.e. oscillatory movement tangential to the interface.

Mode A and Mode B signals may be generated simultaneously e.g. when there is significant density oscillation and oscillatory lateral displacement at the interface, but preferably the strength of the Mode B signals is greater than the strength of the Mode A signals. For optimising the measurability of the Mode B signals relative to the Mode A signals it is preferable that the electrical resistivity of the solid body at the sensor surface is higher than the electrical resistivity of the fluid so that the return path for a majority (and preferably substantially all) of the displacement current caused by the oscillatory lateral displacement of the fluid at the interface is through the fluid. The returning current may then be detected by electrodes disposed in the fluid. Increasing the resistivity of the solid body at the sensor surface also tends to reduce the absolute strength of the Mode A signals which are generated.

Electrical signals may be measured by a pair of electrodes associated with the sensor surface. For example, in one embodiment, in order to measure Mode B signals, the electrodes are positioned to either side of the sensor surface, to detect the displacement current in the fluid caused by the oscillatory lateral displacement of the fluid at the interface. However, in other embodiments (intended primarily for measuring Mode A signals) one of the electrodes may form the sensor surface. More generally, an electrode may detect both Mode A and Mode B signals, as will be the case, for example, if a first portion of the electrode is positioned to the side of the sensor surface, and a second portion forms or overlaps with at least a portion of the sensor surface.

The detector (which typically comprises a pair of electrodes immersed in the fluid) and/or the sensor surface of any of the previous aspects preferably comprises a surface which maintains a stable interface potential with the fluid. This helps to avoid the drift which might otherwise occur when the surface is exposed to the fluid and the sound waves. A stable interface potential may be obtained by passivating the surface. In one embodiment the detector and/or the sensor surface comprises a thiolated gold surface, i.e. the gold surface is passivated by an organic compound containing a thiol group. Examples of such compounds are mercapto-undecanol and mercapto-undecanoic acid. The thiolation may be accomplished according to the method for forming a “self-assembled monolayer” of thiols on an evaporated gold surface described by Bain C. D. et al., J. Am. Chem. Soc., Vol. 111 (1989) pp 321-335. Essentially the sulphur atoms of the thiol groups at one end of the organic compound molecules bond covalently with the gold surface so that the effective surface exposed to the fluid is formed by the groups which terminate the opposite end of the organic compound molecules. In the case of mercapto-undecanol these groups are —OH groups, and in the case of mercapto-undecanoic acid they are —COOH groups. The interface potential of such a surface can then be stabilised by appropriate pH buffering of the fluid.

### BRIEF DESCRIPTION OF DRAWINGS

Examples of simple systems will now be described with reference to the accompanying drawings, in which:—

FIG. 1 is a schematic diagram showing how acoustic excitation can produce an oscillatory lateral displacement of fluid;

FIG. 2 shows schematically the double-layer of ions present at an immersed surface;

FIG. 3 shows schematically an equivalent circuit for the Mode B mechanism;

FIG. 4 shows schematically an equivalent circuit for the Mode A mechanism;

FIG. 5 shows a simplified apparatus schematic of the vessel and associated components;

FIG. 6 shows a simplified electrical circuit block diagram together with a simplified view of the vessel apparatus of FIG. 5;

FIG. 7 shows a cross-section through a second apparatus;

FIG. 8a and b shows respectively side and top view cross-sections through a third apparatus;

FIG. 9 shows a cross-section through a fourth apparatus;

FIG. 10 shows a schematic of a fifth apparatus;

FIG. 11 is a plot of typical waveforms obtained using the apparatus of FIGS. 5 and 6, illustrating the separation of components comprising the detected waveform by means of DC biasing the electrode;

FIG. 12 is a further plot of typical waveforms obtained using the apparatus of FIGS. 5 and 6;

FIG. 13 is a plot of detected voltages illustrating the effect of corroding porous gold-plated brass electrodes, as detected using the apparatus of FIGS. 5 and 6, and Mode A;

FIG. 14 is a plot of typical waveforms obtained using the apparatus of FIGS. 5 and 6, illustrating the effect of the binding of IgG onto a Perspex sensor surface lying between the electrodes;

FIG. 15 is a plot of detected voltages illustrating the effect of the adsorption of human IgG on to Perspex, as detected by the apparatus of FIGS. 5 and 6 and Mode B;

FIG. 16 is a plot of waveforms from the experiment which produced the results shown in FIG. 15;

FIGS. 17a and b show schematic cross sectional front and side views of a sample cell of a further apparatus according to the present invention;

FIGS. 18a and b show schematically the target surface and pick-up electrodes of the sample cell of FIGS. 17a and b;

FIGS. 19a and b show schematically how the sample cell pf FIGS. 17a and b may be adapted to isolate Mode A signals, FIG. 19a being a cross section through the cell and FIG. 19b showing the corresponding approximate electrical equivalent;

FIG. 20 shows two sets of eight overlaid electrokinetic traces, obtained using 16 metallised glass targets, and the corresponding acoustic waveform;

FIG. 21 shows the electrokinetic trace detected with the patterned target (shown in FIG. 18a), the corresponding acoustic waveform, and the electrokinetic trace obtained when no target is present;

FIG. 22 shows an adsorption isotherms for IgG on a glass target;

FIG. 23 shows an adsorption isotherms for BSA on a crystal polystyrene target; and

FIG. 24 shows adsorption isotherms for BSA being adsorbed onto a polystyrene target and subsequently being digested by a solution of protease (Sigma PS147) in phosphate buffer.

### DETAILED DESCRIPTION

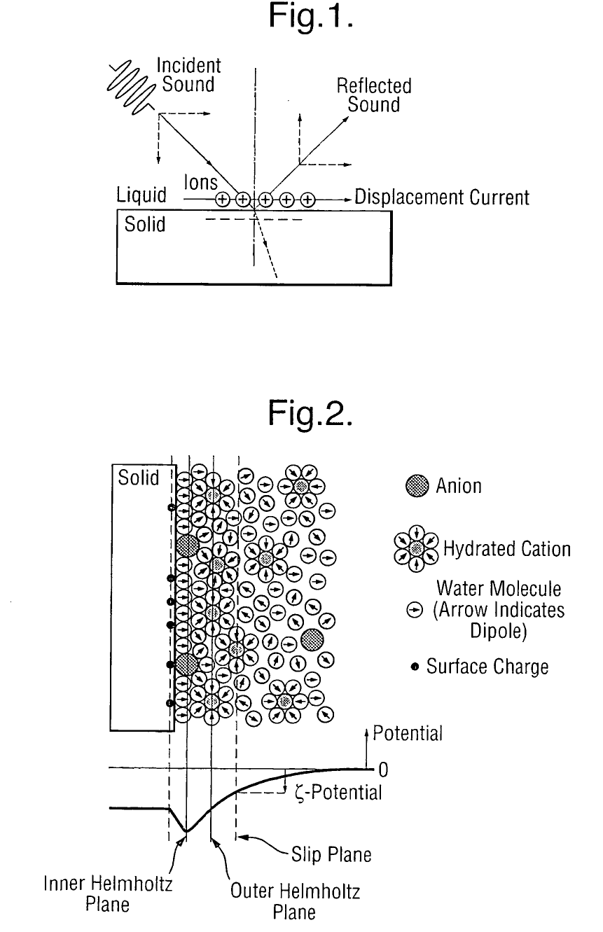

FIG. 1 is a schematic diagram showing how acoustic excitation can produce an oscillatory lateral displacement of fluid (and hence a displacement current) at a fluid/solid interface, which in turn can generate mode B signals. A burst of ultrasound strikes a selected area (i.e. the sensor surface) of an immersed target surface at an oblique angle. The acoustic impedance of the solid surface is substantially different to that of the fluid so that a large proportion of the incident sound is reflected. Considering only the longitudinal pressure waves in the fluid, it can be seen that the components of the displacement vectors normal to the surface will cancel, whereas those parallel to the surface will add. In an ideal, non-viscous fluid, the fluid molecules at the interface will therefore undergo oscillatory motion relative to the solid, in the plane of the interface. This generates a small ion displacement current which causes an oscillating potential in the fluid at two points at either end of the acoustic spot. Such a potential should be detectable in real systems although they will tend to be more complex than this (e.g. because of the dynamic viscosity of fluids).

The double-layer of ions present at an immersed surface is shown schematically in FIG. 2. It is electrically analogous to a parallel-plate capacitor, with the solid surface acting as one “plate” and the layer of hydrated ions attracted electrostatically to the surface as the other. The hydrated ions most closely attracted to the surface are often regarded as becoming entangled in a dense, immobile network, with the remainder of the ions free to move with the fluid. The imaginary plane that separates the mobile outer ions from the rest of the double-layer is referred to as the slip-plane, and possesses an associated electrostatic potential with respect to the fluid—the zeta potential (ζ). As the ions outside the slip-plane can move relatively freely with the fluid they are expected to make up the majority of the displacement current.

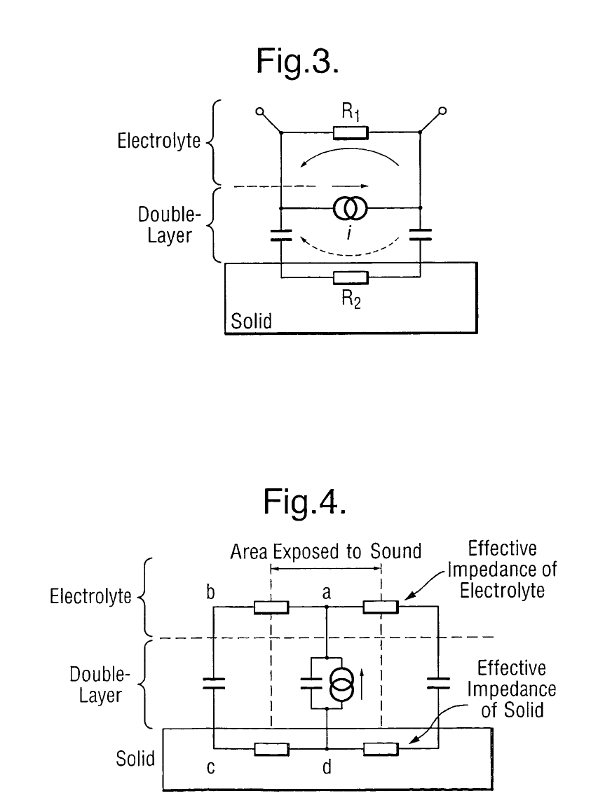

FIG. 3 shows schematically an equivalent circuit for the Mode B mechanism. The capacitors represent the double-layer capacitance for either half of a small acoustic spot, while the resistor R₁ is the impedance of the overlying fluid (which constitutes a return path for the displacement current). R₂ is the resistivity of the solid. If R₂>>R₁, then the majority of the displacement current flows on a return path through the fluid electrolyte. If, however, the solid is a conductor, such that R₂˜0, the majority of the displacement current flows on a return path through the solid, via the double-layer capacitance (which is typically 10 μF/cm²). In this case, the potential drop across R₁ will be negligible so no significant Mode B signal will be detectable.

Turning to the Mode A mechanism, it is believed that the reflection of sound waves from the interface causes a pressure anti-node to be set up, so that molecules at the surface experience a pressure oscillation with an amplitude roughly twice that of the incident wave. Hence the volume occupied by molecules at the interface will oscillate leading to corresponding variations in the double-layer capacitance and the potential of the solid surface.

FIG. 4 shows schematically an equivalent circuit for the Mode A mechanism which, under small-signal conditions, is equivalent to a fixed double-layer capacitance connected in parallel with a current source. If the conductivity of the surface area exposed to ultrasound is much smaller than the conductivity of the fluid electrolyte, insufficient displacement current flows around the loop (a)-(d) to produce a measurable potential drop in the fluid between (a) and (b). Conversely, if the solid is very conductive compared with the fluid, then a substantial current will flow around the loop and set up a measurable potential between the electrodes.

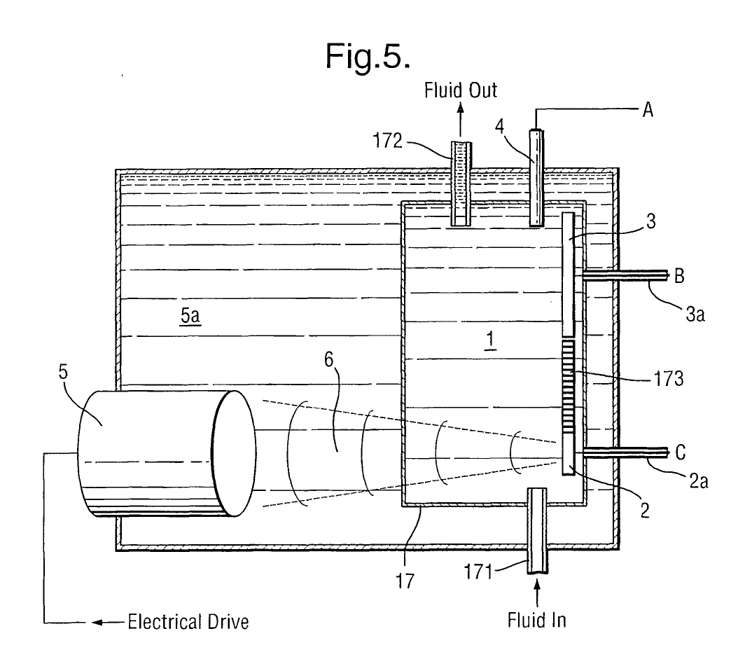

We now describe a simple system according to the present invention. In FIG. 5 there is shown a sample of fluid 1 (typically a conductive electrolyte) disposed in a thin-walled plastic vessel 17 to contain the fluid, with an inlet 171 and an outlet 172 providing for passing the fluid through the vessel. A simple metal electrode 2 (the target electrode, for Mode A) is provided inside the vessel 17 in contact with the fluid and may have a prepared surface. Another simple metal electrode 3 (the counter electrode) provides a second electrical contact to the fluid. For Mode B, an insulating sensor surface 173 may lie between the electrodes. An electrochemical electrode 4 (the reference electrode) is provided in contact with the fluid to enable monitoring of the mean potential of the target electrode. An acoustic source 5 is used to expose the target electrode 2 or sensor surface 173 to known acoustic waveforms via a medium 5a (typically an acoustic coupling fluid water) which serves to introduce a delay between transmission and arrival of the sound 6 at the target.

The vessel is in the form of a Perspex sample cell approximately 3 mm deep along the direction of travel of the sound, with a corresponding window thickness of 1.5 mm. This thickness of Perspex causes negligible attenuation/distortion of the sound waveform. The cell is typically 5-10 mm wide, and 30 mm long (vertically).

The sample fluid 1 typically consists of a 0.1 M to 1 M solution of KNO₃, though other salts (such as NaCl, KI) and other (lower) concentrations have yielded similar results to those obtained. The fluid temperature is typically 18-25 C, and remains steady over the duration of an experiment by virtue of the large thermal capacity of the water bath surrounding the sample cell (a thermostat may also be used to ensure thermal stability).

The target electrode 2 of this example consists of a gold-plated brass screw (8BA) with the exposed end planarised & polished prior to gold plating. An 8BA screw is approx. 2 mm in diameter, and the screws used are approx. 10 mm long. The electrode is screwed in to a tapped hole in a Perspex plate, which forms the back face of the sample cell (and surface 173), such that the polished, plated end is flush with the Perspex surface or slightly recessed. The length of the screw ensures that for a time-window of a few microseconds, the system behaves as an “ideal” fluid-metal interface, before internal reflections from the far end of the screw return to the screw surface. This simplifies analysis and interpretation of the signals obtained, but is not necessarily an essential feature in a practical end-product. The counter electrode 3 is a gold-plated screw similar to the target electrode 2 but wound further in to the sample cell, such that it protrudes approximately 3 mm in to the fluid (thereby providing a much larger contact surface area with the fluid.) It is situated typically 6-8 mm away from the target electrode. A metal plate can be placed over the front of the sample cell to ensure that the counter-electrode is shielded from any diffracted sound, but in practice this has not been found to be necessary. Insulated wire electrical connections 2a and 3a to electrodes 2 and 3 provide respective contact points C and B. As described in more detail below, contact point C is connectable to an amplifier/current-to-voltage converter and DC biasing via a resistor and/or choke, and contact point B allows a DC bias, high-frequency decoupling to ground or an applied alternating voltage/current to be applied to electrode 3.

The reference electrode 4 is a Saturated Calomel Electrode, connected to the sample fluid 1 by a salt bridge typically containing 1 M KNO₃ (porous glass frit connection to sample cell fluid)—this double-junction configuration ensures that certain ions in the sample cannot poison the reference electrode 4. Electrode 4 is connected, via point A, to a high-impedance voltage amplifier (>0.5MΩ) to ensure that minimal current is drawn from the electrode, when necessary.

The acoustic transducer 5 was custom built, consisting of a 10 mm thick×38 mm diameter disc of PC5H PZT ceramic (Morgan Matroc) sandwiched between a brass lens (focal length 80 mm in water) and a brass-based absorber. The lens focuses the sound in the water onto the target electrode (forming a spot approx. 2-3 mm across, depending on frequency); the absorber ensures that waves emerging from the back of the transducer disappear, thereby preventing long undesirable resonances of the system. The simplest sound waveform consists of two pulses of opposite polarity separated by 2.25 μs (the acoustic transit time of the PZT disc) when the transducer is driven by a sudden voltage step. The pulses are about 200 ns wide, typically; a wide variety of waveforms may be used, though. The waveforms are typically transmitted at 10-100 ms intervals, and are estimated to produce a pressure peak of up to 100 kPa at the target electrode surface, though lower pressures may be produced, also yielding measurable signals. The transit time of the pulse to the focal point of the lens through water is approximately 55 μs.

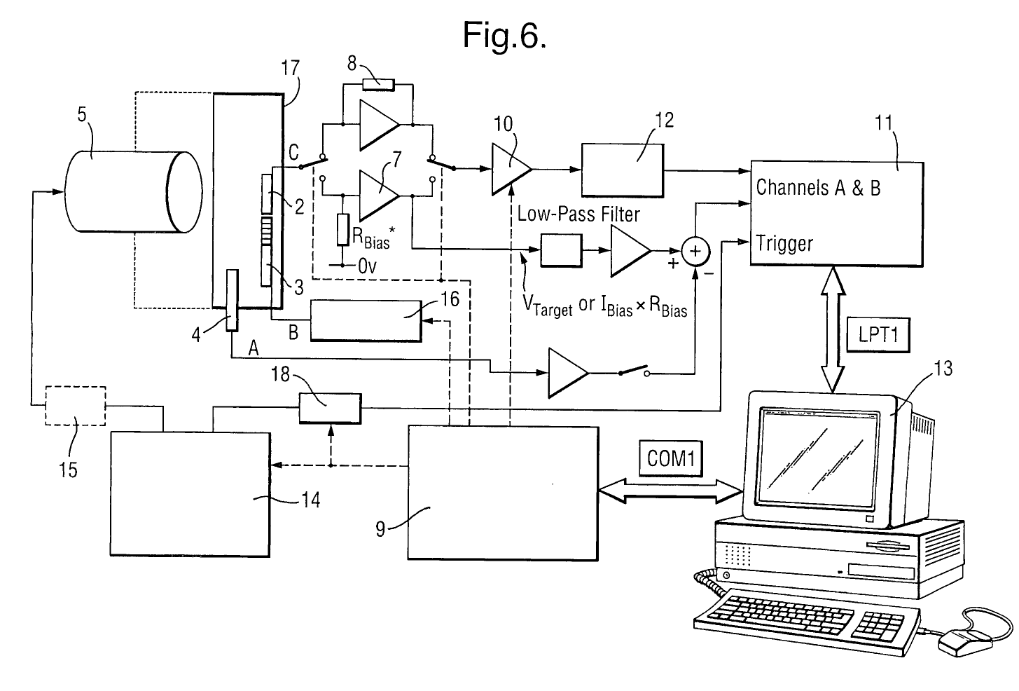

FIG. 6 shows a simplified electrical circuit block diagram together with a simplified view of the vessel apparatus of FIG. 5. A pulse generator 14 provides electrical drive to the acoustic source 5 under the control of a computer 13 via a main control interface unit 9. The pulse generator produces switchable 25 ns-300 ns rise time steps of any voltage up to 350V. Additional circuitry 15 may be inserted to alter the electrical waveform driving the acoustic source 5. The additional circuitry may comprise various circuit components (typically a series inductor) which can be placed in line with the transducer (which is electrically equivalent to a capacitor of ˜1 nF) to induce sinusoidal ringing or other electrical (hence acoustic) wave shapes. Thus in one embodiment the additional circuitry comprises an inductor for an L-C ringing operation. The pulses from 14 may also be used to trigger an external signal source to drive the transducer.

The signals generated at or in the immediate vicinity of the target electrode surface are picked up by the circuitry either as a voltage waveform (using an amplifier 7) or as a current waveform (using a current-to-voltage converter 8). Selection between the two is made under computer control via the main control unit 9, which also determines the amount of amplification at subsequent amplifiers 10 before the signal is fed in to a computer-based (digital) oscilloscope 11 via appropriate (e.g. low pass) filters 12 which are, in this example, 6-pole Bessel filters (12 MHz or 3 MHz, switchable) at 50 Ω coupling.

The digitised waveforms are fed to the computer 13 which stores and processes them. The computer is a 450 MHz Pentium III PC (Intel), 128M RAM, 16 GByte hard disk, running MATLAB and custom software written in C++, integrated in to a custom MATLAB program. Averaging is preferably employed to improve the signal-to-noise ratio, which also has the benefit of effectively improving the voltage-level resolution of the oscilloscope owing to the interaction of random noise with the voltage-level sampling function (‘dithering’). The processed waveform is displayed or further analysed by the computer for interpretation of the results.

The voltage amplifier 7 has a gain of +10, and an input impedance of 1M Ω∥3 pF, though an optional 10 kΩ resistor (R_{bias}) may be inserted as shown in FIG. 6 to permit biasing current to flow during certain tests. R_{bias} can be connected and disconnected remotely under the control of main control unit 9. Amplifier 7 is a low-noise amplifier (6 nV/√Hz) with a 25 MHz bandwidth. The current-to-voltage converter 8 is also low-noise (2.2 pA/√Hz) with a gain of 50 V/A, and a similar bandwidth to the amplifier 7. The subsequent amplifiers 10 provide a switchable gain of 100-1000 and also have low noise at 25 MHz bandwidth.

The main control unit 9 also includes a programmable delay means 18 for deriving a digital signal from the pulse generation circuitry 14 which has a consistent, programmable time delay relative to the driving waveform applied to the acoustic source 5. This delayed, digital signal is used to trigger the oscilloscope 11 to start collecting data a short time before the expected arrival of the acoustic pulse at the target electrode 2, relieving the computer of a critical timing function. This delayed digital signal may also be used to trigger a signal generator (not shown) to apply an electrical waveform to the electrodes as the acoustic stimulus arrives, via the point ‘B’. The latter facility provides for studying the response of the electrode surface to sudden changes in potential on the time-scale of a single acoustic burst (e.g. sweeping ions though adsorbed protein layers as discussed earlier.)

The main control interface unit 9 is custom-designed and built, and based around a PIC17C43 microcontroller. It accepts a range of instructions from the computer via a serial link (RS232) and controls the rest of the apparatus accordingly.

The oscilloscope 11 samples at up to 100 MSamples/s, and is triggered by the main control interface unit 9 to collect data at the time the acoustic pulse is estimated to reach the target electrode. It has selectable voltage ranges down to 50 mV full range, with 8-bit resolution.

A separate block of circuitry 16 also under supervision from the computer 13 via the main control interface unit 9 permits the application of DC electrical biases across the electrode pair. The circuitry 16 may also be configured to control the application of radio-frequency signals across the electrodes, via an external connection to point ‘B’ (not shown). Thus the effects of high-frequency excitation (e.g. frequency mixing) may be studied. The programmable bias source is a switchable DC voltage source (8-bit DAC, −1.25 to +1.25V currently installed) with optional decoupling capacitors at the counter electrode 3 to ensure a low-impedance A.C. earth connection when required.

The reference electrode 4 monitors the potential of the sample fluid 1 relative to the common electrical earth potential of the circuitry. From this reading, the potential of the target electrode may be monitored (either at equilibrium, or under the influence of a bias applied by circuitry 16). By disconnecting the reference electrode 4, the same oscilloscope channel may be used to monitor the mean current flowing through the target electrode 2 via the 10 KΩ bias resistor, giving an indication of the electrochemical activity of the latter (especially under the influence of a bias voltage.)

The main unit 9 has additional outputs operated by the computer that permit the control of further stimuli (as referred to earlier) such as a magnetic coil (not shown), for applying a magnetic field to the target electrode 2.

The computer, being programmable, provides a flexible means of controlling experiments.

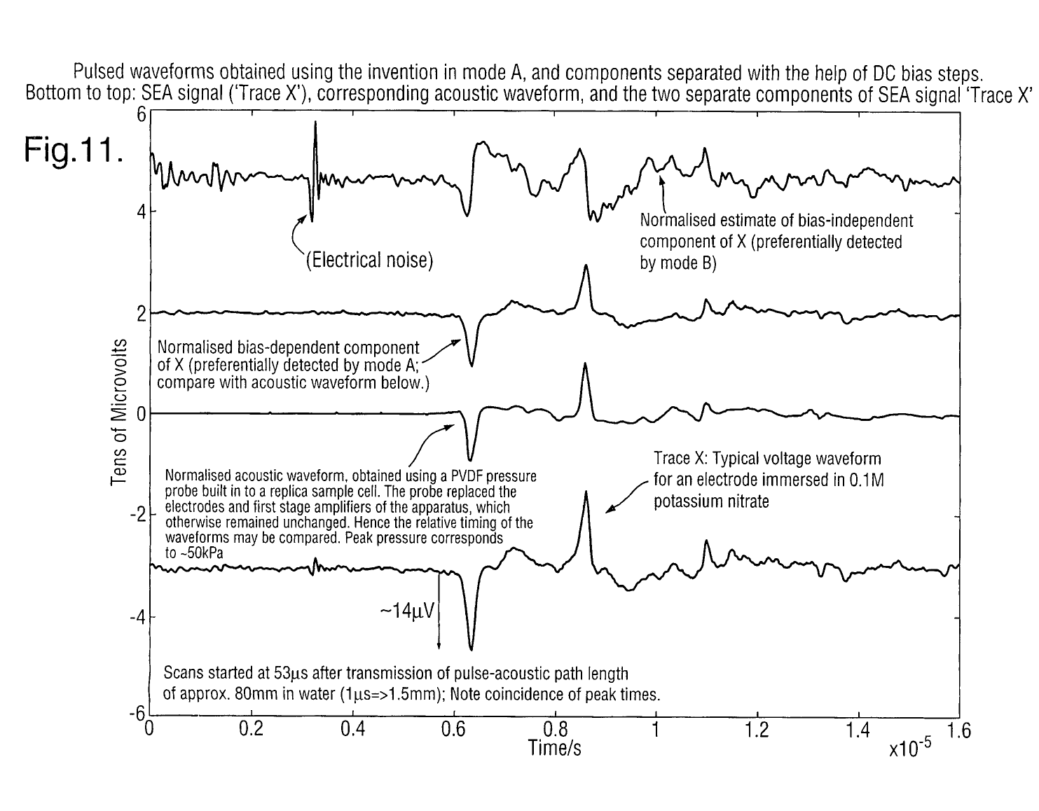

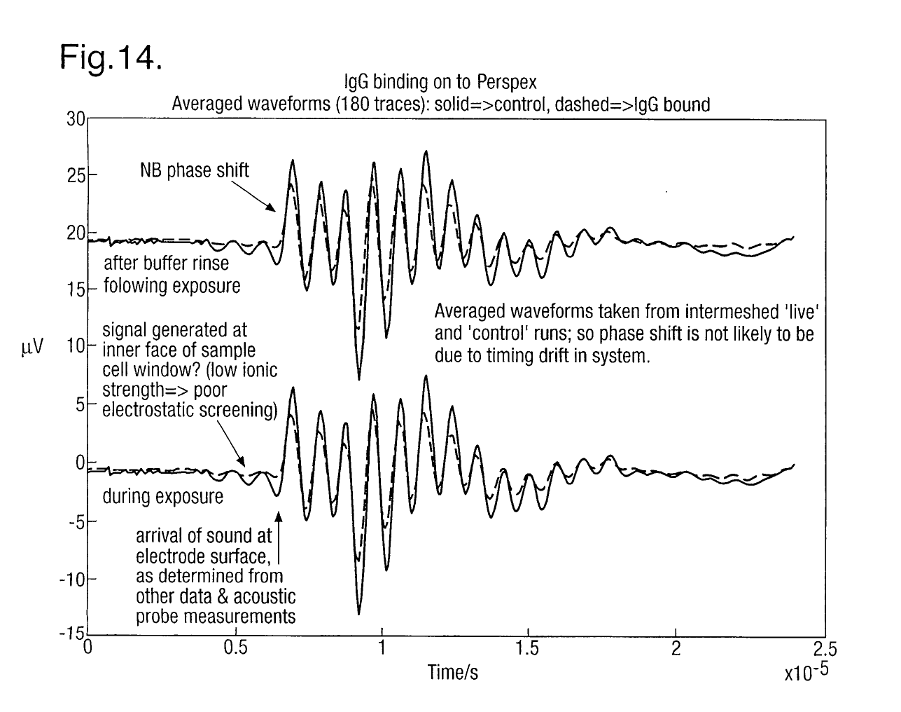

The apparatus described above is a typical embodiment, which has been constructed and used to produce the results represented in FIGS. 11 to 16.

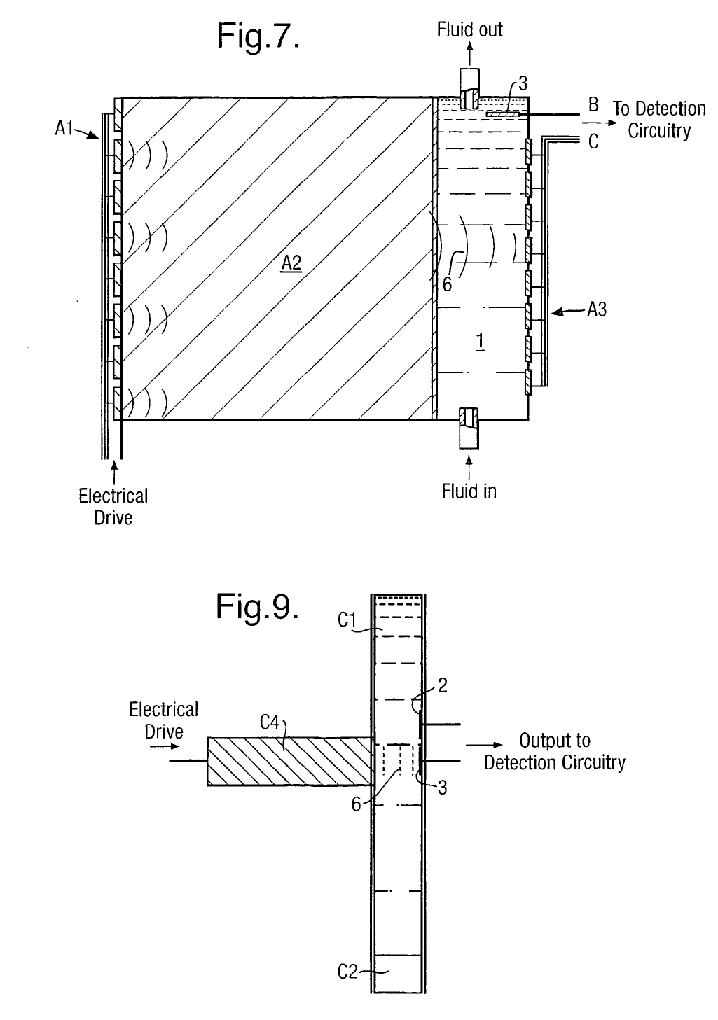

A further example of apparatus according to the invention is shown in FIG. 7. This shows an apparatus comprising an array of acoustic sources A1, driven such that superposition of the sound waves during transit through the block of material A2 leads to a focussed spot of sound on arrival at the surface of an array of prepared target sensor surfaces A3. Detection and processing of the signals could be carried out using electronic apparatus similar to that detailed in FIG. 6, with the modification that provision is made to address separately the electrodes comprising the array A3.

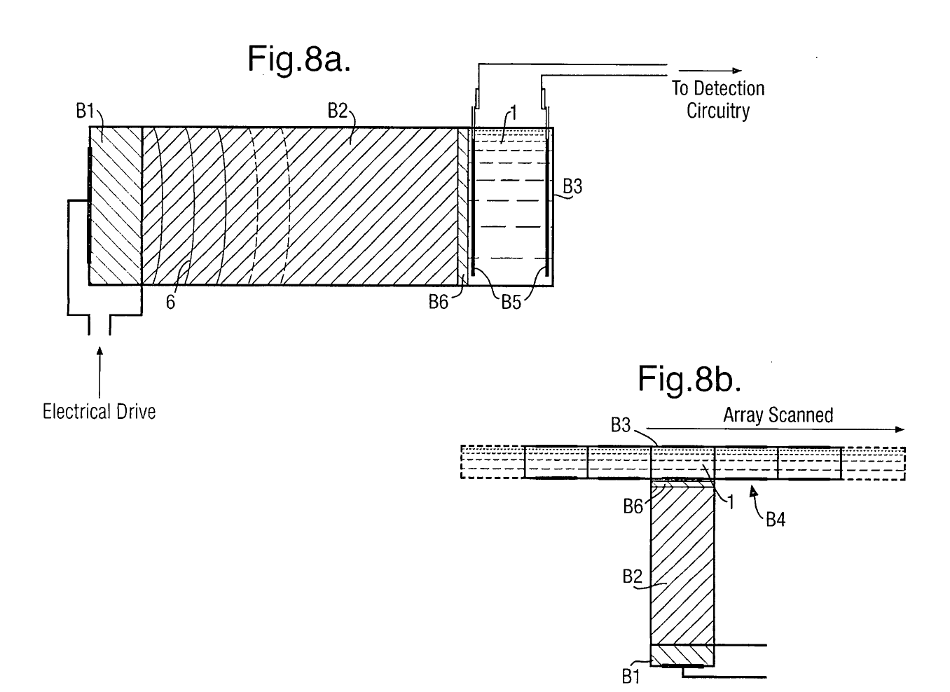

A further example of apparatus according to the invention is shown respectively in side and top view cross sections in FIGS. 8a and b. This shows an apparatus comprising an acoustic source B1, a solid block B2 acting as an acoustic delay line, a disposable plastic cell B3 possibly comprising part of an array of cells B4 with thin metal electrodes deposited on opposing walls B5. Again, electrical apparatus similar to that detailed in FIG. 6 can be used to detect the signals occurring at the electrode(s). A (lubricated) acoustic coupling layer B6 allows the acoustic source and delay line to be scanned across successive cells of the cell array.

A still further example of apparatus according to the invention is shown in FIG. 9. This shows an apparatus consisting of a column of gel C1 serving to separate species introduced or inserted at C2 by electrophoretic or similar means. Target 2 and counter 3 electrodes oppose acoustic source C4 across the column, the acoustic source stimulating one of the electrodes to produce the signal as described above. The magnitude of the signal indicates the concentration of species present in the vicinity of the electrode at any given time. Electrical apparatus similar to that detailed in FIG. 6 could be used to detect the signals produced by the electrode.

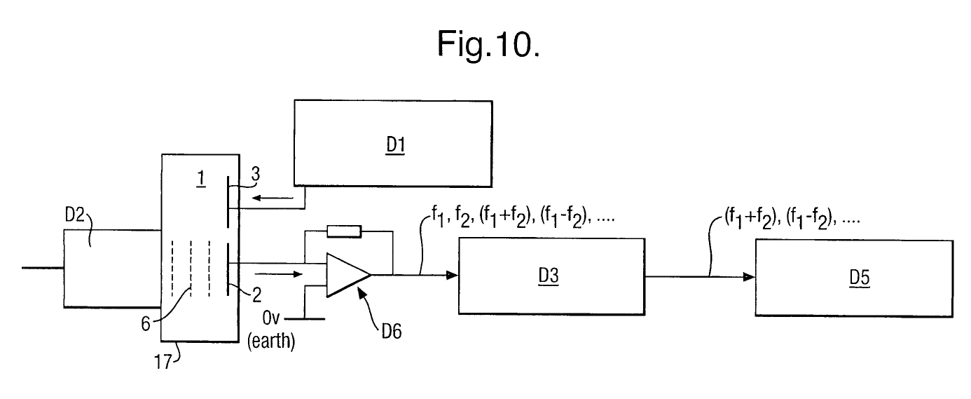

FIG. 10 shows an apparatus similar to that shown in FIG. 5, but with additional accompanying circuitry. An alternating electrical signal is applied across the target 2 and counter 3 electrodes from source D1 at frequency f₁, while the target electrode is stimulated by the acoustic source D2 driven at frequency f₂ (possibly continuously). A current-to-voltage converter D6 connected to target electrode 2 produces an electrical signal having frequencies f₁, f₂, (f₁+f₂), (f₁−f₂), etc. Filters D3 (blocking f₁ and f₂) serve to separate components of the electrical signal present at D4, discarding all but those which are due to mixing effects occurring at the electrode surface. Detection circuitry D5 measures the amplitudes and phases of these remaining components as a means of quantifying the interactions occurring at the electrode surface.

Experiments

The apparatus as depicted in FIGS. 5 and 6 was used to obtain the results shown in FIGS. 11 to 16.

Voltage and current waveforms have been observed at the electrode, bearing a strong relationship to the applied acoustic waveform.

The time delay between the transmission of a pulse of sound, and the occurrence of an electrical pulse at the electrode, is identical to the delay measured between transmission and reception of the sound by an acoustic probe placed at the point where the electrodes are usually positioned. Hence it is clear that the phenomenon occurs in the vicinity of the electrode surface rather than in the bulk of the fluid; recent experiments provided a spatial resolution of approx. 200 μm within a sample cell 3 mm deep.

When a focussed acoustic spot is fired at the target electrode, the observed voltage signal typically contains two components:

(i) a component which is strongly dependent on the mean potential of the target electrode with respect to the solution, as expected for the signal generation mechanism preferentially detected by Mode A.

(ii) a component which is independent of the mean potential of the target electrode, and strongly dependent on the conductivity of the fluid sample, as expected for the signal generation mechanism preferentially detected by Mode B.

For clarity, these two components have been separated with the aid of biasing and computer processing, and are shown in the upper half of FIG. 11.

The magnitudes of the signal components are entirely consistent with simple models for the generation mechanisms described.

The dependence of the amplitude of component (i) on the mean target electrode potential is important, since it shows that the observed signal is not due to an Ion Vibration Potential arising in the bulk of the fluid.

The persistence of the change in signal amplitude after application and removal of bias, even when the fluid sample is changed mid-experiment, confirms that the physical phenomenon underlying Mode A is sensitive to the condition of the electrode surface (which is altered by the applied bias). Since no substantial change in electrical impedance for the electrodes has been observed during biasing (and since negligible current is drawn from the system when the Voltage probe option is used anyway) it must be concluded that the modulation of component (i) is a direct result of a modulation of the generation phenomenon (otherwise it could be suggested that the signal is generated away from the electrodes and that the observed change in signal amplitude is simply a result of reduced electrical sensitivity).

The persistence described above also shows that the change in signal is not related to the presence of a current density in the fluid in front of the electrode surface.

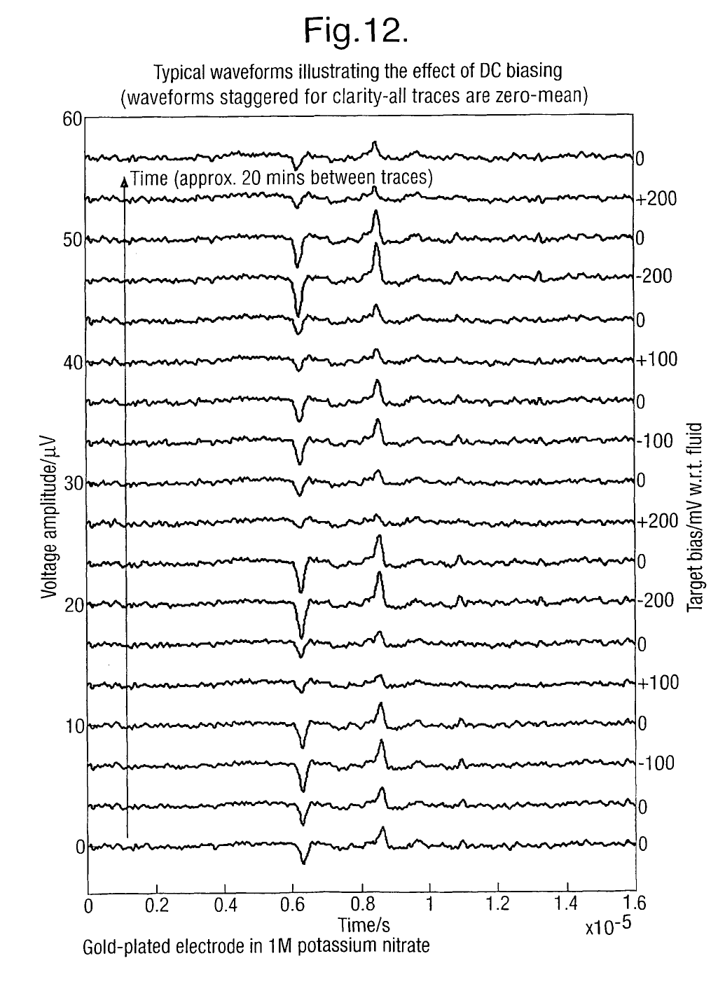

As shown in FIG. 12, the polarity of the observed signal component (i) relative to the polarity of the applied acoustic waveform has been seen to swap over in response to an applied bias—this should not occur unless the signal is generated within the double-layer at the electrode surface, and should certainly not occur if the signal is generated in the bulk of the fluid as a result of an Ionic Vibration Potential (it indicates that the net potential difference across the layers responsible for the generation of the signal has changed sign).

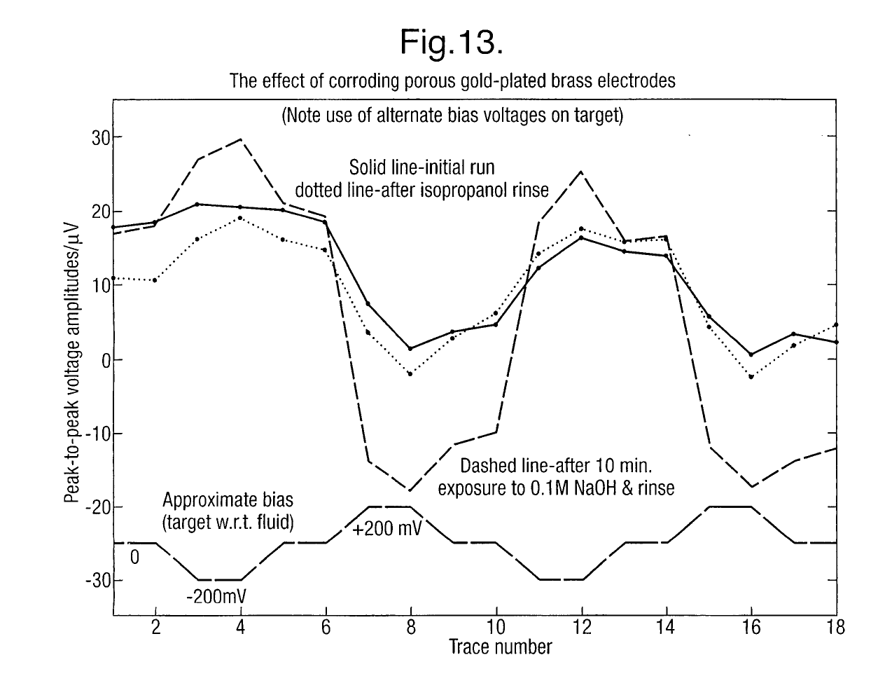

Rinsing of a set of electrodes with different solutions has resulted in changes in the signal, and the extent to which it can be modulated by an applied bias. This confirms the potential for using the invention to monitor the status of an electrode. For example, FIG. 13 shows the result of corrosion of a brass surface by NaOH.

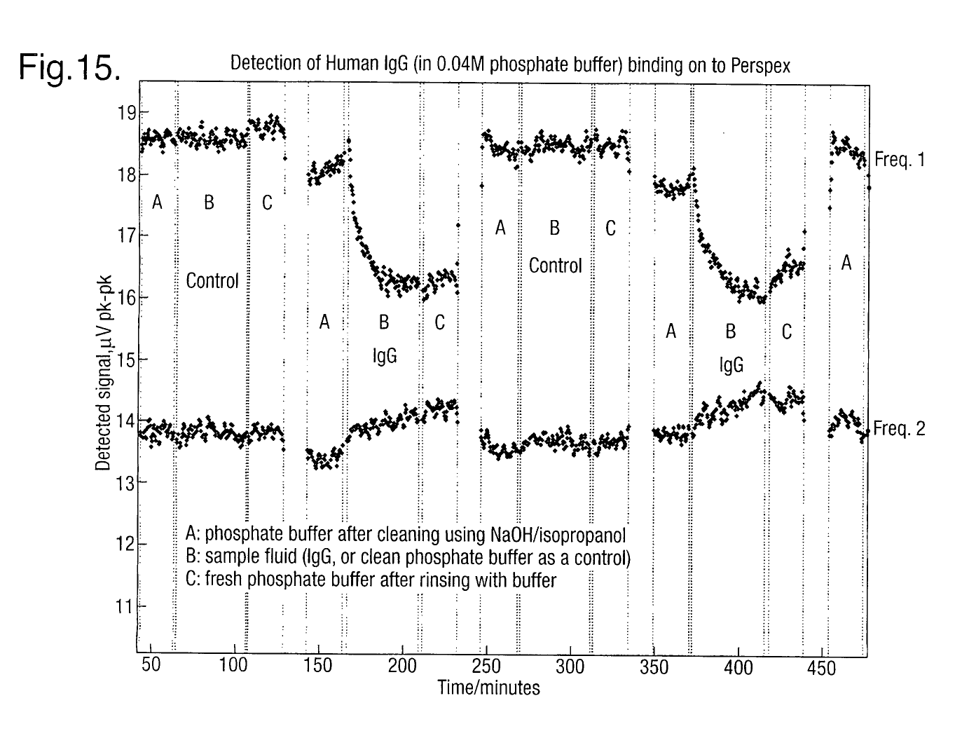

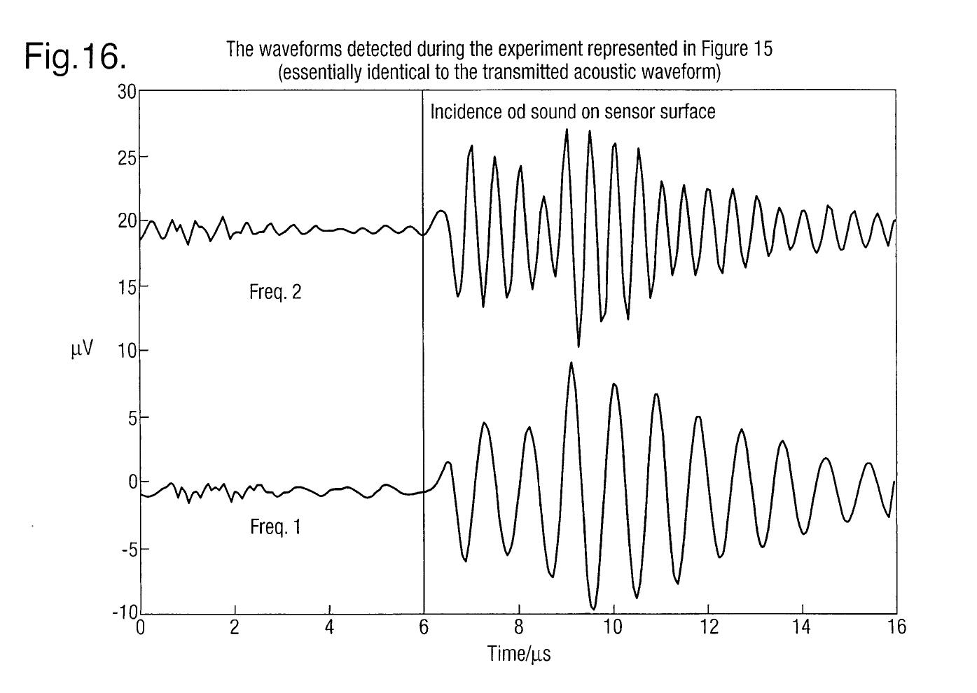

FIGS. 15 and 16 demonstrate the potential for detecting biological species using the invention in Mode B. A spot of sound is focussed, using an acoustic lens, on to the target electrode. A signal will be detected corresponding to the compression of the double-layer overlying the electrode; but in addition, provided the spot overlaps the Perspex immediately surrounding the target electrode, a signal will be generated here too, by the motion of the fluid (the spatially decaying spot of sound generates a region of radial fluid motion at the Perspex surface, inducing a radial current and therefore altering the fluid potential at the target electrode).

At Frequency 1 (1.11 MHz), the decaying edge of the spot of sound overlaps the Perspex by some 2-3 mm, inducing the radial fluid motion over the Perspex. At Frequency 2 (1.998 MHz) the spot is concentrated almost entirely on the metal electrode, so that only the signal generated by double-layer compression remains.

Human IgG, at a concentration of approximately 50 mg/L (in phosphate buffer, pH 7.4) was rinsed over Perspex that had been thoroughly cleaned with NaOH/isopropanol. The introduction of IgG-bearing solution is clearly marked by exponential curves corresponding to the adsorption of the protein on to the prepared surface, at Frequency 1. The persistence of the change in the signal, following removal of fluid-borne IgG, confirms that the observed change is associated with modification of the sensor surface. Subsequent removal of the adsorbed IgG (using sodium hydroxide and isopropanol) results in regeneration of the sensitive surface, with the signal reverting to former levels. The use of a control solution (clean phosphate buffer) in alternate experimental runs confirms that the changes observed can only be due to the presence of IgG.

It is clear that the signal at Frequency 1 responds to the presence of IgG, but at Frequency 2 the response is hardly visible, suggesting that the sensitivity of the system is due to the mechanism preferentially detected by Mode B, which is only dominant at Frequency 1 (measurements at the two frequencies were taken alternately, comprising the same experimental run).

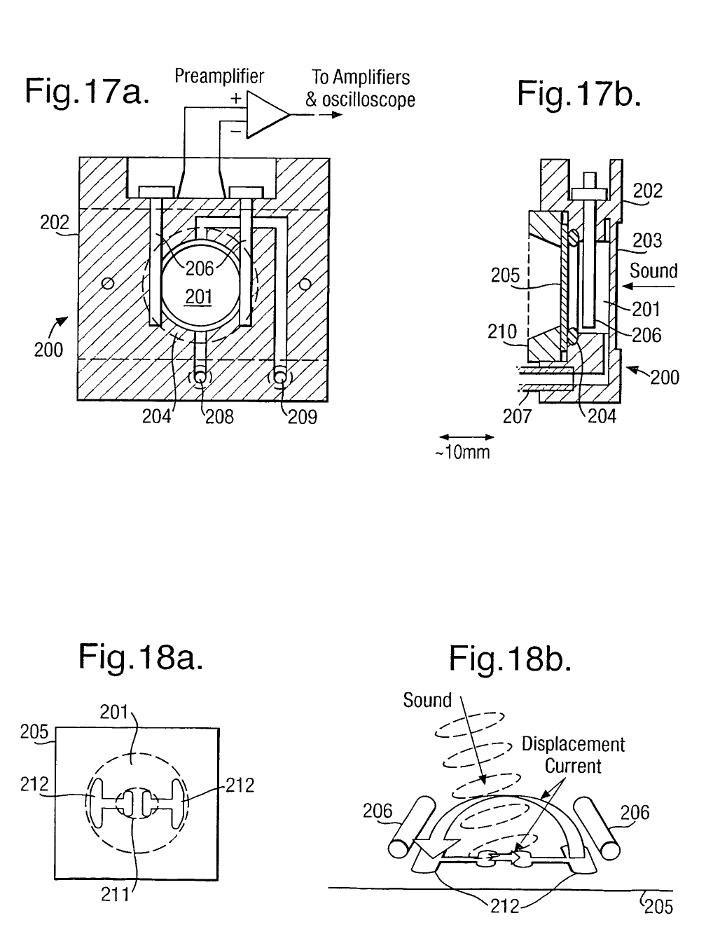

We now describe a further system according to the present invention. FIGS. 17a and b show cross sectional front and side views of a sample cell 200 held in a water tank (not shown). The cell comprises a cylindrical cavity 201 formed in a Perspex block 202 with a thin Perspex front window 203 and Viton O-ring 204 at the back against which target surface 205 is clamped by a ring-shaped back plate 210 to seal the cavity. Two stainless steel pick-up electrodes 206 are mounted to either side of the cavity. The electrodes are connected via the shortest possible leads to electrical circuitry similar to that shown in FIG. 6.

Fluid is fed into the cavity 201 via Tygon tubing 207 at fluid inlet 208 and outlet 209, so that the contents of the cell can be changed without disturbing the alignment of the cell with an ultrasonic transducer (not shown) which directs focussed ultrasound through the front window and at the target surface typically at an angle of 15° from the normal to the target surface. The ultrasound traverses the distance between the front window and the target surface in about 4 μs, producing an acoustic spot −4 mm across on the target surface.

The temperature of the water in the water tank immediately adjacent to the acoustic beam is monitored by an electronic thermometer. It can be important to know the water temperature as a small drift in the temperature can cause the phase of the measured electrical signal relative to the transmitted ultrasound to shift appreciably (the speed of sound in water varies with temperature, so that the acoustic transit time from the transducer to the target surface changes as the water temperature varies), and recovery of the signal phase can be important for extracting the magnitude of the Mode B signal (as explained below).

As shown in FIGS. 18a and b, the pick-up electrodes 206 are spaced further apart than the size of the acoustic spot 211. However, the target surface is modified before use by the evaporation of thin patterns 212 of gold onto the surface, the gold patterns being thiolated immediately after evaporation. The acoustic spot effectively defines the sensor surface of the target.

Each gold pattern is associated with one of the electrodes. The gold diverts the vibration current round a much larger loop through the fluid as shown in FIG. 18b. The pick-up is therefore much improved, with the electrodes detecting 40% of the voltage present between the metallised areas. Effectively, each gold pattern may be regarded as an extension of the corresponding pick-up electrode, the gold pattern being indirectly coupled to the pick-up electrode via the (relatively small) fluid gap which spaces the pick-up electrode from the target surface. However, each gold pattern may also be regarded as forming a portion of the sensor surface as the acoustic spot overlaps the gold pattern.

An advantage of this method of indirect coupling is that the displacement current signal generated at the gold surface is much more controlled than it would be at the surfaces of the steel electrodes if they were positioned closer to the acoustic spot. The gold is passivated with a monolayer of thiol molecules and the dissociable groups which terminate the thiol molecules maintain a well-defined and stable electrochemical equilibrium with the (suitably pH buffered) fluid in the cavity 201. Exposing unpassivated electrodes to the sound waves would risk introducing drift into the measured electrical signals. Also target surfaces with different shaped patterns can be readily introduce into the cell. For example, to measure Mode A signals it can be advantageous for the metallised area to completely cover the acoustic spot (as described below)

Experiments performed using the system of FIGS. 17 and 18 are described below.

Target Metallisation

Before metallisation, the target surfaces were cleaned thoroughly using repeated sonication, first alternating between a solution of sodium dodecyl sulphate and UHP water, then isopropanol, then alcohol. In the evaporator, the targets were further cleaned in situ by exposure to an oxygen plasma for 5 min, before deposition of 0.5 nm of chromium (for adhesion), followed by 50 nm of ultra-pure gold. On removal from the evaporator, they were placed in a −200 mg/l solution of mercapto-undecanol or mercaptoundecanoic acid dissolved in ethanol, and kept in the dark until use (no peeling or bubbling of the deposited metal film was observed at any point, even after the targets had been used in experiments).

Solutions

Unless otherwise stated, all solutions were based on 0.01 M, pH 7.6 phosphate buffer (prepared in UHP water).

Clean buffer (minimum 10 cm³) was used for rinsing the cell where appropriate. For removing protein and cleaning the cell, a three-step process was used. First, the cell was rinsed with an elution buffer of 0.5 M NaOH, isopropanol and 2% Hellmanex (in the volume ratio 2:1:1) for 5 min. After a thorough rinse with UHP water, the cell was then filled with a 200 mg/l solution of protease (Sigma P5147) for 5 min, to digest denatured protein residues. The cell was further rinsed with UHP water, flushed with the elution buffer for another 5 min, and thoroughly rinsed with UHP water and phosphate buffer.

Protein solutions were made up using human immunoglobulin (IgG, Sigma 14506) and bovine serum albumin (BSA, Sigma B4287). Prior to loading the sample cell with a protein solution, the cell was drained to avoid dilution of the incoming solution with any remaining fluid.

Degassing

To prevent bubbles from forming in the tank and scattering the focused sound, all experiments were conducted using water that was first heated at atmospheric pressure, then cooled in a sealed container overnight under a slight vacuum.

Characterising the Mode A Signal

Before using the patterned targets to detect protein adsorption, it was necessary to confirm that the Mode A signal generated over the metallised areas would remain constant, as predicted.

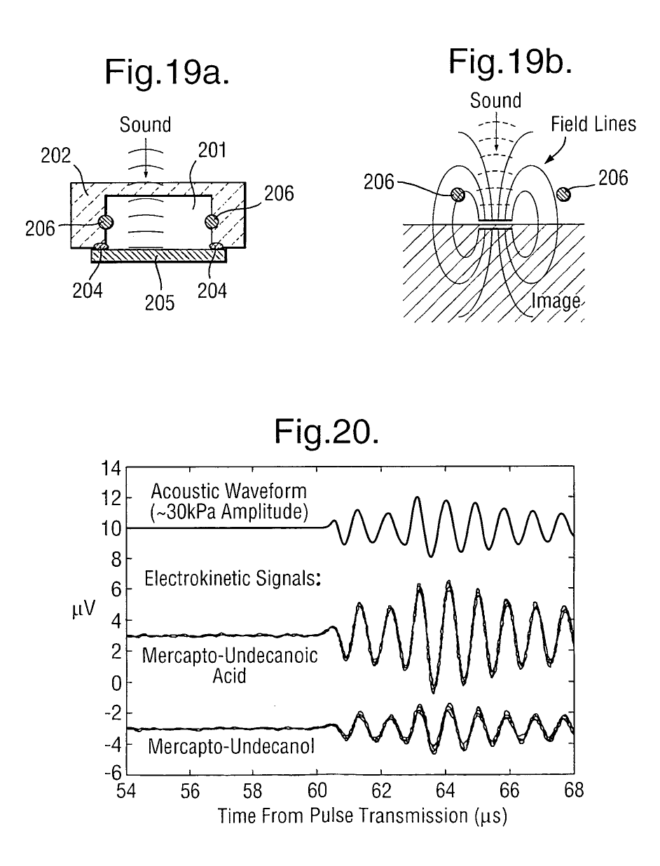

Although the system is designed primarily for the detection of Mode B signals, it can also be used to detect a Mode A signal in isolation as shown in FIGS. 19a and b. A Mode A signal is generated by sound striking a completely metallised area (i.e. a thiolated gold layer completely covers the acoustic spot) at normal incidence, to one side of the axis of symmetry of the sample cell. The electrokinetic source, combined with its image in the conductor, behaves as an extended dipole. The vibration potential in the fluid falls radially from the axis of the dipole, so that the nearer electrode picks-up a stronger signal, and the differential signal is therefore non-zero (the metallisation is restricted to a disc that fits inside the Viton O-ring, so that it is electrically isolated from the water outside the sample cell).

So as to establish that the signal detected this way is indeed generated at the surface, an experiment was conducted prior to exposing the targets to proteins. FIG. 20 shows two sets of eight overlaid electrokinetic traces, obtained using 16 metallised glass targets, immersed in 0.01 M, pH 7.6 phosphate buffer and exposed to acoustic bursts of −30 kPa amplitude. The spot focus was offset from the sample-cell centre by 3 mm. For comparison, the acoustic waveform is also shown (as detected by a thin-film hydrophone mounted on a dummy target, and placed in the sample-cell). Eight targets were thiolated with mercapto-undecanol, and eight with mercapto-undecanoic acid. Measurements were taken alternating between the two thiol types; the respective traces have been separated out and displaced by ±3 μV for clarity. The targets prepared with the acid form of the thiol exhibit a much stronger signal, because the dissociated —COOH groups confer a substantial negative charge at pH 7.6 (the potential drop between the solution and the thiol surface is much greater for the acid because of the higher charge density, so the Mode A signal is proportionately larger). By contrast, the surface coated with alcohol-terminated thiols carries little net charge, so the signal is weak. The dependence of the electrokinetic signal on the thiol type proves unambiguously that it is originating partly or wholly from the target surface. It also demonstrates how the Mode A signal can be used to monitor the surface charge density inside the slip-plane.

Characterising the Mode B Signal

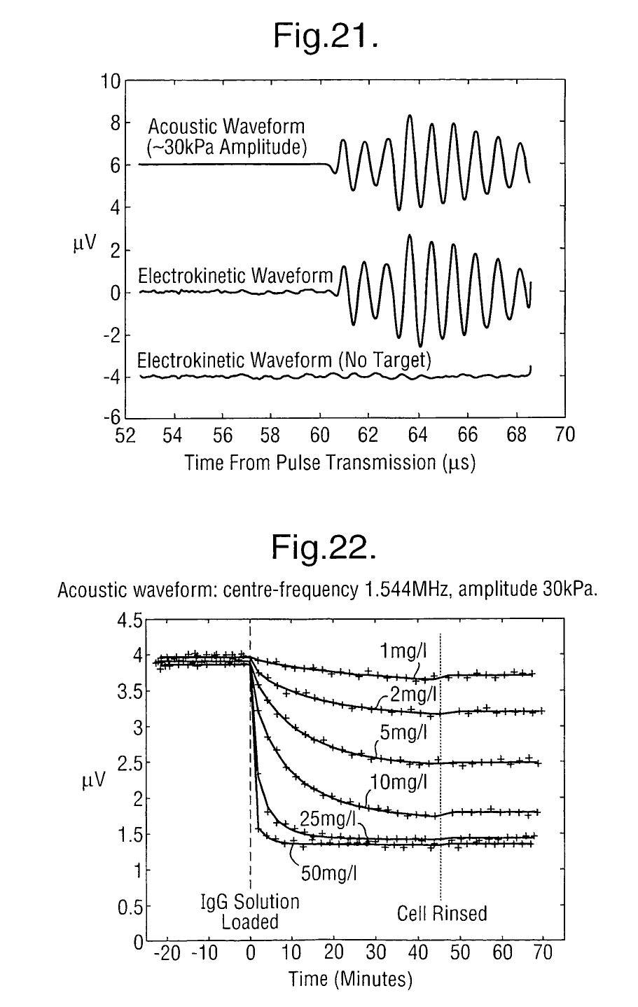

FIG. 21 shows the electrokinetic trace detected with the patterned target (as shown in FIG. 18a) immersed in 0.01 M, pH 7.6 phosphate buffer and positioned with the sound striking the surface at 15° to the normal. The detected pressure waveform is also shown. The weak signal just visible 4 ps ahead of the main signal is a Mode B signal generated at the inside of the Perspex window. This can be compensated for, by recording the signal detected with the target replaced by a hollow fluid-filled cell (lower trace in FIG. 21), and subtracting the signal afterwards. However, averaging over the 61-69 μs time-slot, the window signal introduces an error of only around 3% at most.

The detected signal is dominated by the wanted Mode B component, but it also contains an appreciable contribution from the Mode A signal generated over the metallised areas; there will also be a small Ionic Vibration Potential, generated in the fluid. Although the Mode A and Ionic Vibration Potential components remain constant (provided the solution pH is maintained by the buffer), they have an adverse effect on the measured signal, and should be removed before protein adsorption kinetics are studied. This is most easily achieved by processing the raw data after the experiment, and selecting the phase angle along which the signal variation is largest during protein adsorption. For this reason the signal phase should be free of any other drift, and hence the desirability of estimating the thermal phase shift from the temperature reading of the water bath.

Adsorption Isotherms

To demonstrate the use of the system for investigating protein adsorption kinetics, a variety of metallised targets (of the type shown in FIG. 18a) were exposed to solutions carrying different proteins at a range of concentrations (the targets were stored in a solution of mercapto-undecanol prior to use).

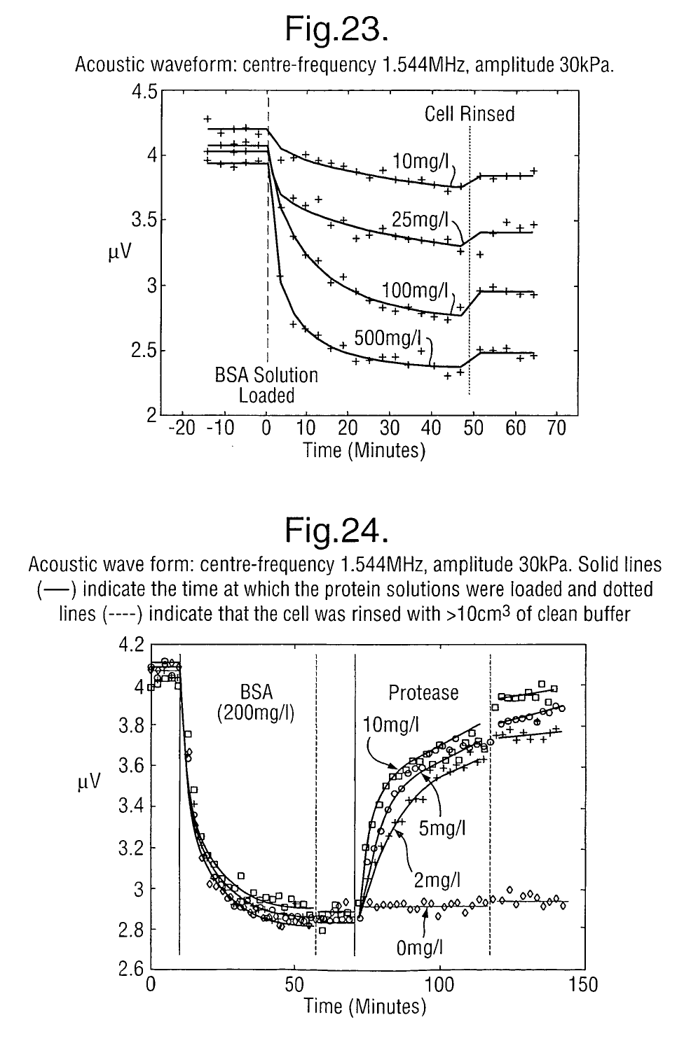

Typical IgG and BSA adsorption isotherms are shown in FIGS. 22 and 23, with the Mode B signal amplitude being recovered using phase-sensitive detection as described above.

In each case, the signal drops as the surface becomes covered with protein. This indicates that the proteins carry a lower charge at pH 7.6 than the native surface, in agreement with their respective pI values (3.5, 7.5 and 4.7, for glass, IgG and BSA—note the scale on FIG. 23). The reduction in signal may be due to a decrease not only in the density of counter-ions, but also in their mobility. A surface covered in proteins will probably have a greater tendency to entangle hydrated ions than a native glass or plastic surface, reducing the proportion of mobile ions. Limited acoustic motion of the adsorbed proteins with the fluid is also feasible, further reducing the net current. The saturation visible in FIG. 22 for 50 mg/l IgG is assumed to correspond to the surface being entirely covered with protein.

The system can also be used for studying interactions between proteins. FIG. 24 shows adsorption isotherms (the Mode B signal amplitudes being recovered using phase-sensitive detection) for BSA being adsorbed onto a polystyrene surface and subsequently being digested by a solution of protease (Sigma PS147) in phosphate buffer. The initial rate of digestion increases with protease concentration, although it is interesting to observe that the gradients become very similar after 15 min or so.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

Glauser A. R. et al., Sensors and Actuators B 4039 (2001) 1-15 and all the publications mentioned above are hereby incorporated by reference.

1. A method of detecting the chemical and/or biological properties of a fluid, or of a surface in contact with a fluid, the method comprising
disposing a sensing surface in a vessel;
disposing adjacent the sensing surface a detector for measuring electrical or magnetic signals generated in the fluid immediately adjacent the sensing surface;
disposing the fluid in the vessel;
using an acoustic source to generate sound waves and direct the sound waves at the sensing surface; and
measuring the electrical or magnetic signals generated in the fluid immediately adjacent the sensing surface by the detector at the time when the sound waves impinge on the fluid immediately adjacent the sensing surface.

2. A method according to claim 1, wherein the sound waves impinge on the said one or more sensor surfaces out of phase, but said one or more sensor surfaces are positioned so that the sound at one arrives out of phase with the sound at the other.

3. A method according to claim 1, wherein the sound waves impinge on the said one or more sensor surfaces identically, the said one or more sensor surfaces having a different composition.

4. A method according to any of claims 1 to 3, including the step of preparing the electrode surface to provide said sensor surface.

5. A method according to any of claims 1 to 4, including the step of preparing the electrode so as to modify the sensitivity of the apparatus to particular species, thereby enhancing the selectivity of the device.

6. A method according to any of claims 1 to 5, including the further step of modifying or replacing the fluid sample so as to modify the signal observed at the electrode, thereby deducing
electrical, chemical or biological properties of the electrode surface or associated layers, or
properties of fluids to which the electrode has been previously exposed.

7. A method according to claim 2 including the step of modifying or replacing the original fluid sample with a further fluid sample, and deducing chemical or biological properties of the further fluid sample by monitoring the effect on the signal observed at said one or more electrodes.

8. A method according to any of claims 1 to 7, wherein the sensor surfaces are placed in contact with a medium which itself provides a means of identifying or separating species to be detected, such that the variation of the signal detected at the electrodes provides a means of quantifying these species.

9. A method according to any of claims 1 to 8, including the steps of separately measuring (a) the potential difference between two electrodes when no current flows between them, and (b) the current flowing between the same electrodes when they are held at fixed potentials, in the same fluid medium, thereby obtaining separate and further information on the electrodes and/or associated charged/polarised layers.

10. A method according to any of claims 1 to 9, including the further step of separating the fluid sample from the source of acoustic energy by enclosing it in a vessel which is in acoustic contact with the acoustic source, via a solid or a second fluid.

11. A method according to any of claims 1 to 10, including the further step of inserting a section of material between the acoustic source and the fluid sample or vessel, to deliberately increase the propagation delay of the sound waves, thereby providing greater temporal separation between the stray electrical fields present at the acoustic source during excitation and a signal generated in the vicinity of the electrode surface(s) for measurement of the change.

12. A method according to any of claims 1 to 11, including the further step of modulating the electrical drive to the source of the acoustic signal, such that the propagation delay of the acoustic signal from the source to the vicinity of the electrodes serves to separate the electrical signals generated in the vicinity of the electrodes from the electromagnetic signals which are present at the apparatus during the generation of the acoustic signal at the source, thereby to eliminate the unwanted influence of stray electromagnetic coupling between the acoustic transmitter apparatus and the electrode receiver apparatus.

13. A method according to any of claims 1 to 12, including the step of positioning multiple acoustic sources and driving them such that the sound waves generated superimpose at particular electrodes within an array, thereby enabling interrogation of the layers adjacent to differently selected electrodes without the need to mechanically reposition the electrode array or the acoustic source.

14. A method according to any of claims 1 to 13, including the step of simultaneously applying a varying electrical potential between two or more of the electrodes, via suitable electrical coupling which enables separation of the signal(s) generated acoustically from the applied electrical potential, to monitor the effect on the former.

15. A method according to any of claims 1 to 14, including the step of applying an additional stimulus, such as heat, light, a magnetic field, or ionizing radiation and deducing properties of the electrode surface or associated layers by monitoring the effect of this additional stimulus on the measured change.

16. A method according to any of claims 1 to 15, comprising the further step of repeating the measurements of electrical signals while altering the nature of the applied acoustic waveform so as to obtain further information on the electrode surface or associated layers.

17. A method according to claim 15, comprising the step of attaching a deformable, chemically passive layer to one or more electrode surfaces before applying a layer of particles to be studied, and alternating the frequency of the applied acoustic signal such that the motion of the deformable layer alternately promotes adsorption and desorption of the original and/or subsequently added particles.

18. A sensing apparatus for detecting the chemical and/or biological properties of a fluid, or of a surface in contact with a fluid, the apparatus comprising:
a vessel for containing the fluid;
a sensing surface in the vessel;
a detector for measuring electrical or magnetic signals generated in a fluid in the vessel immediately adjacent the sensing surface;
an acoustic source arranged to generate sound waves and direct the sound waves at the sensing surface; and
an electrical circuit connected to the detector and arranged to measure the electrical or magnetic signals generated in the fluid immediately adjacent the sensing surface by the detector at the time when the sound waves impinge on the fluid immediately adjacent the sensing surface.

19. An apparatus further to claim 18, wherein the acoustic source is provided with an acoustic lens, to focus the sound on to one or more selected electrodes.

20. An apparatus further to claim 18 or claim 17, wherein the potential of one or more of the electrodes relative to the sample fluid is deduced by means of an additional electrochemical electrode in contact with the sample fluid.

21. An apparatus further to any of claims 18 to 20, in which the electrodes comprise an array, separately prepared so as to simultaneously obtain information on the effect of a single sample fluid on different materials or compounds associated with each electrode.

22. An apparatus according to any of claims 18 to 21, in which the electrodes comprise a conductive coating on a substrate incorporating an acoustically sensitive material allowing near-simultaneous comparison of the measured change with the acoustic stimulus present at the electrode.

23. An apparatus according to any of claims 18 to 1922 wherein the means for measuring the change comprises a receiver is attached to the electrodes, with provision for applying electrical signals to the electrodes.

24. An apparatus according to claim 23, wherein the receiver includes an amplifier.

25. An apparatus further to any of claims 18 to 24, comprising for selectively detecting components of the signal present at the electrodes, and displaying or storing information obtained from these signals.

26. An apparatus according to claim 24, wherein the amplifier is a first amplifier comprising a current-to-voltage converter.
